(19) United States
(12) Patent Application Publication
(10) Pub. No.: US 2019/0374319 A1
(43) Pub. Date: Dec. 12, 2019

(54) FULL DENTURE PROCESSING AND SHAPING METHOD AND MATERIAL BLOCK THEREOF

(71) Applicants: WEN-HSIN CHIOU, Taichung City (TW); JHEN-GUO TSAI, Tainan City (TW)

(72) Inventors: WEN-HSIN CHIOU, Taichung City (TW); JHEN-GUO TSAI, Tainan City (TW)

(21) Appl. No.: 16/001,473

(22) Filed: Jun. 6, 2018

(51) Int. Cl. A61C 13/08; A61C 13/36; A61C 13/00; A61C 13/01; B29C 45/14; B29C 45/00; B29C 45/40

(52) U.S. Cl. CPC A61C 13/081; A61C 13/1016; A61C 13/0022; A61C 13/082; A61C 13/01; B29L 2031/7536; B29C 45/0055; B29C 45/40; A61C 2201/002; B29K 2995/002; B29C 45/14008

(57) ABSTRACT

A full denture processing and shaping method and a material block thereof are disclosed. The full denture processing and shaping method comprises the follow steps of: providing a hard colored material block to be positioned to a processing device, a portion of the hard colored material block being shaped into a tooth-shaped structure; mounting the hard colored material block in an injection mold; injecting a soft plastic material with a different color into the injection mold, the soft plastic material being polymerized to form a gingival colored material block to constitute a multicolor structure; demoulding the injection mold to take out the material blocks for processing, the gingival colored material block being shaped into a denture base.

### FIELD OF THE INVENTION

The present invention relates to a processing and shaping method and a material block thereof, and more particularly to a full denture processing and shaping method and a material block thereof.

### BACKGROUND OF THE INVENTION

The demand for making a full denture is common for elderly patients or those who suffer from bad habits (such as smoking, eating betel nut, etc.), resulting in complete loss of teeth. The most common full denture is in the form of a movable denture, which usually includes a whole set of maxillary teeth and mandibular teeth. A conventional method for producing and processing a full denture is to process the bottom part of the denture base, and an engaging groove is formed at a predetermined position during processing, and then commercially available standard artificial resin teeth are adhered to the engaging groove of the denture base in sequence so as to complete a full denture product. This producing and processing method is common, but there are some deficiencies in this method. 1. The teeth may disengage from the denture base easily. 2. It is not easy to control the adhesive, which affects the position of the artificial resin tooth in the engaging groove. 3. There is a displacement error. In addition, if it is desired to complete the full denture structure with one-time processing of the artificial resin, it only has a single color (for example, the entire product only shows the color of the teeth) and cannot have the real colors of the human teeth and the denture base, that is, it is unable to distinguish the color of the human teeth from that of the denture base.

### SUMMARY OF THE INVENTION

The primary object of the present invention is to provide a full denture processing and shaping method, without the need of adhesion that may cause displacement errors. The full denture has hard and soft parts with different colors.

Another object of the present invention is to provide a material block which can be accurately and repeatedly positioned in the processing and shaping process through a positioning portion of the material block, thereby effectively improving the convenience of processing and the precision of the finished product.

According to one aspect of the present invention, a full denture processing and shaping method is provided. The full denture processing and shaping method comprises the follow steps of:

providing a hard colored material block, the hard colored material block having a predetermined positioning portion;

positioning the hard colored material block to a processing device for performing a first processing, the first processing being to shape a portion of the hard colored material block into a tooth-shaped structure in a predetermined arrangement;

mounting and securing the hard colored material block in an injection mold;

injecting a soft plastic material into the injection mold, the tooth-like structure being partially covered with the soft plastic material, the soft plastic material having a color different from that of the hard colored material block, a region where the soft plastic material is injected being polymerized to form a gingival colored material block to constitute a multicolor structure;

demoulding the injection mold to take out the hard colored material block and the gingival colored material block, the positioning portion of the hard colored material block being mounted to the processing apparatus;

performing a second processing, including shaping the gingival colored material block into a denture base to finish a full denture with different colors.

According to another aspect of the present invention, a material block is provided. A predetermined area of the material block is formed with a positioning portion. The positioning portion includes one of a positioning hole, a positioning shaft, a positioning groove and a positioning edge or a combination thereof.

### BRIEF DESCRIPTION OF THE DRAWINGS

FIG. 1 is a first schematic view of the shaping process of the present invention;

FIG. 2 is a second schematic view of the shaping process of the present invention;

FIG. 3 is a third schematic view of the shaping process of the present invention;

FIG. 4 is a fourth schematic view of the shaping process of the present invention; and

FIG. 5 is a fifth schematic view of the shaping process of the present invention.

### DETAILED DESCRIPTION OF THE PREFERRED EMBODIMENTS

Embodiments of the present invention will now be described, by way of example only, with reference to the accompanying drawings.

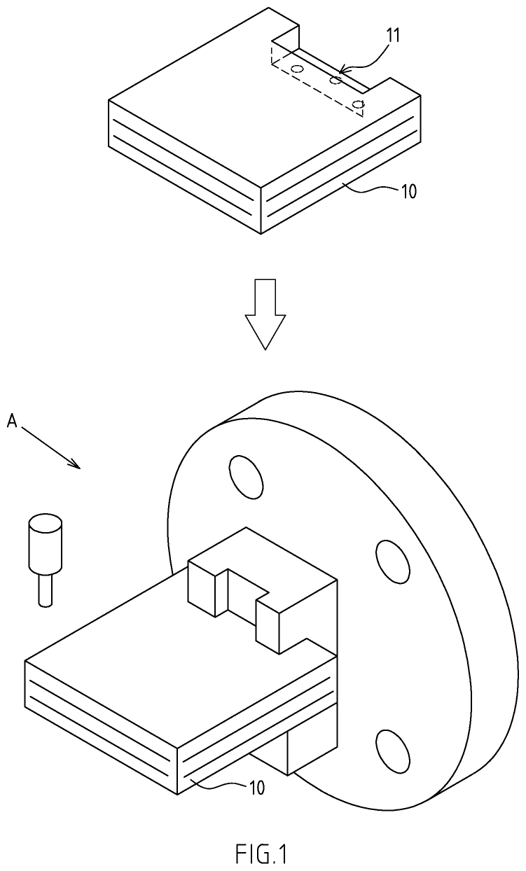

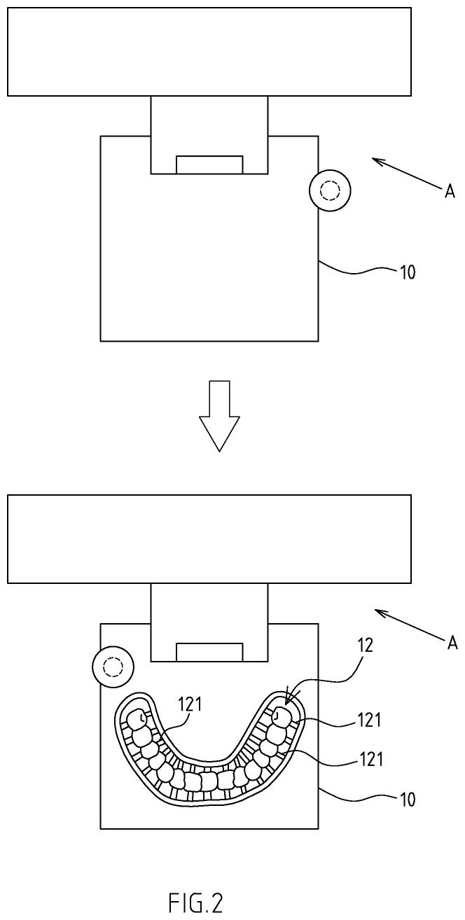

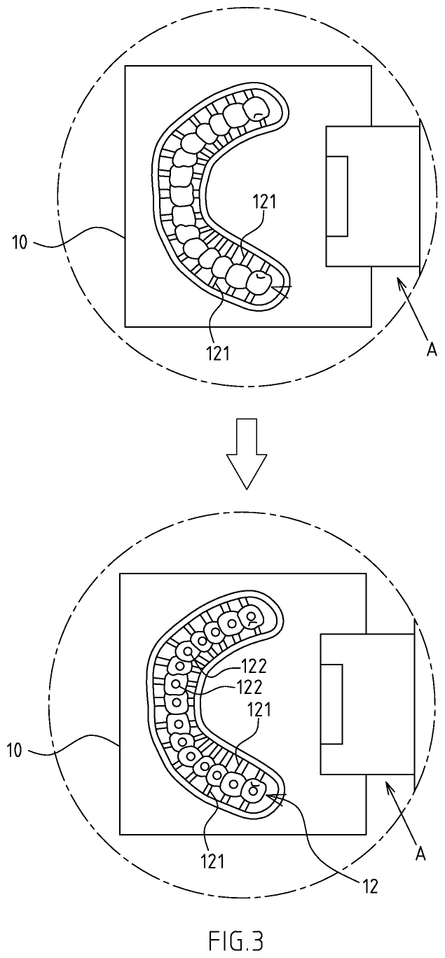

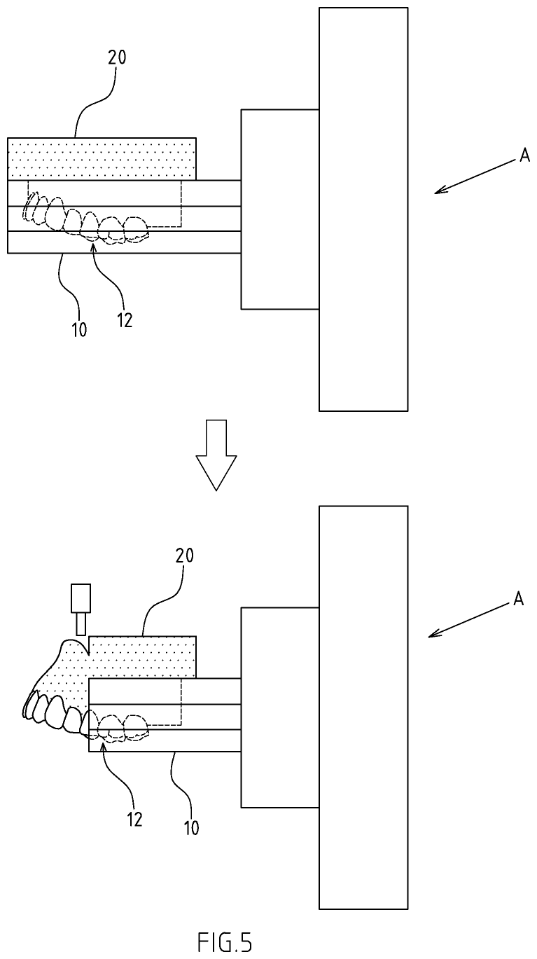

Firstly, referring to FIG. 1 to FIG. 5, the present invention provides a full denture processing and shaping method. The full denture processing and shaping method comprises the follow steps.

A hard colored material block 10 is provided. The hard colored material block 10 has a predetermined positioning portion 11. The positioning portion 11 includes one of a positioning hole, a positioning shaft, a positioning groove and a positioning edge or a combination thereof, but not limited thereto.

The hard colored material block 10 is positioned to a processing device A for performing a first processing. The first processing is to shape a portion of the hard colored material block 10 into a tooth-shaped structure 12 in a predetermined arrangement. Specifically, the tooth-like structure 12 formed by the first processing has a plurality of connecting portions 121 connected with the hard colored material block 10. In practice, the hard colored material block 10 can be repeatedly and precisely positioned on the processing device A through the positioning portion 11 so that the top or the bottom of the hard colored material block 10 can be processed.

The hard colored material block 10 is mounted and secured in an injection mold 13.

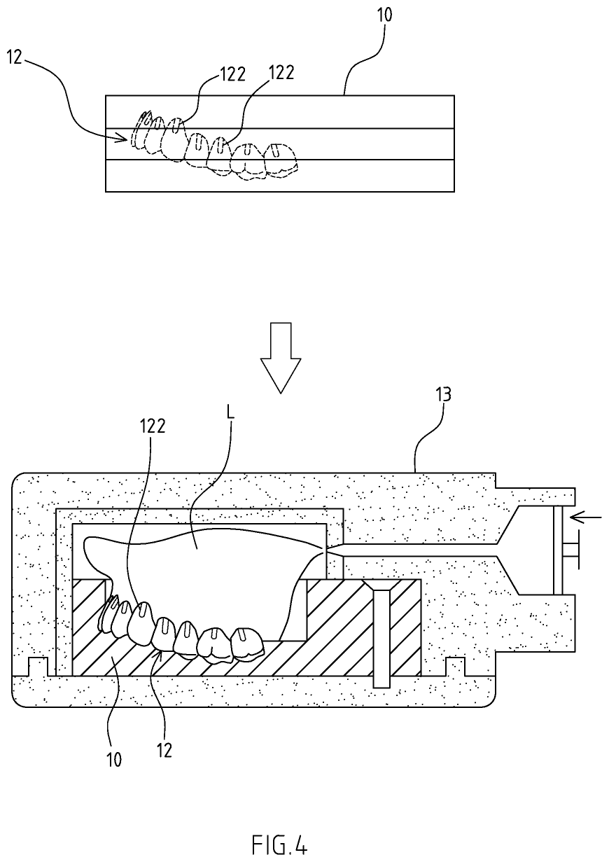

A soft plastic material (denoted by L, only shown in FIG. 4) is injected into the injection mold 13. The tooth-like structure 12 is partially covered with the soft plastic material. The color of the soft plastic material L is different from that of the hard colored material block 10. The region where the soft plastic material is injected is polymerized to form a gingival colored material block 20 to constitute a multicolor structure. In specific implementation, the hard colored material block 10 is made of a composite resin material with a tooth color, and the soft plastic material is made of a plastic material with a gingival color.

The injection mold 13 is demoulded to take out the hard colored material block 10 and the gingival colored material block 20. The positioning portion 11 of the hard colored material block 10 is mounted to the processing apparatus A.

Performing a second processing includes shaping the gingival colored material block 20 into a denture base so as to finish a full denture with different colors. The present invention further provides a material block (i.e., the above-mentioned hard colored material block 10). The detailed implementation will not be described again.

The main specific embodiment and effects of the present invention are described below. Please refer to FIG. 1 to FIG. 5.

In the first processing to form the tooth-like structure 12, the hard colored material block 10 is taken out, one end of the tooth-like structure 12 is drilled to form bores 122, and then the hard colored material block 10 is mounted and secured in the injection mold 13. When the soft plastic material L is injected into the injection mold 13, the bores 122 of the tooth-like structure 12 are filled with the soft plastic material L.

Compared with the conventional processing and forming method, the present invention can directly represent the finished product with vivid colors and also has different soft and hard parts. The present invention not only greatly improves the quality and sophistication of the finished product but also prevents the finished product from falling off. The problem of the lack of quality, practicality, and the like can be greatly improved due to the fact that conventional adhesive is liable to cause the displacement error of the finished product.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A full denture processing and shaping method, comprising the follow steps of:
providing a hard colored material block, the hard colored material block having a predetermined positioning portion;
positioning the hard colored material block to a processing device for performing a first processing, the first processing being to shape a portion of the hard colored material block into a tooth-shaped structure in a predetermined arrangement;
mounting and securing the hard colored material block in an injection mold;
injecting a soft plastic material into the injection mold, the tooth-like structure being partially covered with the soft plastic material, the soft plastic material having a color different from that of the hard colored material block, a region where the soft plastic material is injected being polymerized to form a gingival colored material block to constitute a multicolor structure;
demoulding the injection mold to take out the hard colored material block and the gingival colored material block, the positioning portion of the hard colored material block being mounted to the processing apparatus;
performing a second processing, including shaping the gingival colored material block into a denture base so as to finish a multicolor full denture with different colors.

2. The full denture processing and shaping method as claimed in claim 1, wherein in the first processing to form the tooth-like structure, the hard colored material block is taken out, one end of the tooth-like structure is drilled to form bores, and then the hard colored material block is mounted and secured in the injection mold.

3. The full denture processing and shaping method as claimed in claim 2, wherein when the soft plastic material is injected into the injection mold, the bores of the tooth-like structure is filled with the soft plastic material.

4. The full denture processing and shaping method as claimed in claim 1, wherein the tooth-like structure formed by the first processing has a plurality of connecting portions connected with the hard colored material block, the hard colored material block is made of a composite resin material with a tooth color, and the soft plastic material is made of a plastic material with a gingival color.

5. A material block applied to any one of claim 1, a predetermined area of the material block being formed with a positioning portion, the positioning portion including one of a positioning hole, a positioning shaft, a positioning groove and a positioning edge or a combination thereof.

6. The material block as claimed in claim 5, wherein the material block has a tooth color.
